(19) United States
(12) Patent Application Publication
(10) Pub. No.: US 2009/0282478 A1
(43) Pub. Date: Nov. 12, 2009

(54) METHOD AND APPARATUS FOR PROCESSING NETWORK ATTACK

(76) Inventor: Wu Jiang, Chengdu (CN)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/435,001

(22) Filed: May 4, 2009

(30) Foreign Application Priority Data
May 9, 2008 (CN) 200810096183.6

(51) Int. Cl. G06F 21/00; G06F 17/30; G06F 7/04; G06F 11/30

(52) U.S. Cl. 726/22; 707/3; 709/223; 707/E17.014

(57) ABSTRACT

A network attack processing method and a processing apparatus are disclosed herein. The method may include; after determining an attacked object, searching for a recorded attack event related to the attacked object to determine a controlled host in an attack network; searching for a recorded control event related to the controlled host to determine a controlling host in the attack network; and determining a detected host which performs similar communication with the multiple controlling hosts as an attack manipulator. Accordingly, embodiments for a processing apparatus adapted to perform the methods are disclosed herein.

This application claims priority to Chinese Patent Application No. CN200810096183.6 filed May 9, 2008, titled “Method and Apparatus for Processing Network Attack”, the entire content of which is incorporated herein by reference.

### TECHNICAL FIELD

The present invention relates to the field of communication technologies, and in particular, to a network attack processing method and a processing apparatus.

### BACKGROUND

Distributed Denial of Service (DDOS) attack is a type of flood attack, whereby an attacker uses a controlling host as a springboard (possibly in multiple levels and multiple layers) and controls several infected hosts to create an attack network to stage a massive denial of service attack on the victim hosts. Such attacks tend to amplify the attack of a single attacker by orders of magnitude, resulting in grim consequences to the victim hosts and serious network congestion.

Some solutions for detecting DDOS attacks use several modes of operation. For example, some modes include, traffic exception detection, detection of frequency of sending packets, and detection of feature packets. Traffic exception detection is based on the principles that the traffic of each protocol is steadily changing under normal circumstances and changes abruptly only when attacked. After traffic is collected, a traffic measurement is performed and analyze based on a traffic. The analysis result is compared with the initial analysis model. If the difference between analyzed traffic and the initial analysis model is greater than a threshold, it is deemed abnormal. In the detection of frequency of sending packets mode of operation, the frequency of sending packets is measured, and the statistic result is compared with a preset threshold. If the statistic result is greater than the threshold, it is deemed abnormal. In the detection of feature packets mode of operation, the features of received packets are compared with an existing attack feature library. If any attack packet or controlling packet is identified, it is deemed abnormal.

### SUMMARY

A method for processing network attack provided in some embodiment consistent with present invention may include: after determining an attacked object, searching for a recorded attack event related to the attacked object to determine a controlled host in an attack network; searching for a recorded control event related to the controlled host to determine a controlling host in the attack network; and determining a detected host which performs the same communication with the multiple controlling hosts as an attack manipulator.

An apparatus for processing network attack provided in an embodiment of the present invention includes: an attacked object modeling module, adapted to determine the attacked object; a topology module, adapted to, after the attacked object modeling module determines the attacked object, search for a recorded attack event related to the attacked object to determine a controlled host in an attack network, and search for a recorded control event related to the controlled host to determine a controlling host in the attack network; and a communication analysis module, adapted to determine a detected host which performs the same communication with the multiple controlling hosts as an attack manipulator.

### BRIEF DESCRIPTION OF THE DRAWINGS

FIG. 1 is an exemplary flowchart of a network attack processing method consistent with some embodiments of the present disclosure;

FIG. 2 is an exemplary flowchart of a network attack processing method consistent with another embodiment of the present disclosure;

FIG. 3 shows an exemplary logic structure of main contents of a DBTT consistent with some embodiments of the present disclosure;

FIG. 4 shows an exemplary structure of a processing apparatus consistent with some embodiments of the present disclosure; and

FIG. 5 shows an exemplary structure of a processing apparatus consistent with another embodiment of the present disclosure.

### DETAILED DESCRIPTION

As shown in FIG. 1, in some embodiments, a network attack processing may include:

Step 101: Determining an attacked object. The attacked object may be determined according to priority information of traffic exception events.

Step 102: Searching for a recorded attack event related to the attacked object to determine a controlled host in the attack network. In the created attack real-time list, for example, the IP address of the attacked object may be used as a match condition to look for the attack event targeted at the attacked object. The attack real-time list may be obtained after the collected information of multiple events is sorted by destination IP addresses. The multiple events may include, but are not limited to, frequency over-threshold event, DDOS attack event, or connection exhaustion event.

Step 103: Searching for a recorded control event related to the controlled host to determine a controlling host in the attack network. In a created control real-time list, for example, the IP address of the controlled host may be used as a match condition to look for the control event which uses the controlled host as a control object. The control real-time list may be obtained after the collected information of various control events is sorted by source IP addresses.

Step 104: Determining a detected host which performs the same communication with the multiple controlling hosts as an attack manipulator.

The relevant events mentioned in some embodiments may include, but are not limited to, protocol traffic exception event, frequency over-threshold event, DDOS attack event, connection exhaustion event, and DDOS control event. Other events may include mass spam send events. These events may be obtained by reading the log information of the relevant events from the logs which may be obtained by filtering the database. The information associated with some of these events is described below.

Table 1 shows the data structure of the text body of a frequency over-threshold event.

TABLE 1

| | | | | | | |
|---|---|---|---|---|---|---|
| Destination | Source | Destination | Source | Protocol | Frequency of | Accumulated |
| IP address | IP address | port | port | type | sending | quantity |
| | | | | | packets | |

In Table 1, “frequency of sending packets” indicates the frequency of sending packets, and “accumulated quantity” means the accumulated quantity of packets of this type collected over a period of time.

Table 2 shows the data structure of the text body of a connection exhaustion event.

TABLE 2

| | | | | | | |
|---|---|---|---|---|---|---|
| Destination IP | Source | Destination | Source | Protocol | Connection | Accumulated |
| address | IP | port | port | type | frequency | quantity |
| | address | | | | | |

In Table 2, “connection frequency” means the frequency of connection between a host and a destination host, and “accumulated quantity” means the accumulated quantity of connections collected over a period of time. The communication state described by the connection exhaustion event may mean that a host generates many connections to a destination host during a short period time, which goes beyond the thresholds of connection frequency and accumulated quantity. Table 3 shows the data structure of the text body of a DDOS attack event.

TABLE 3

| | | | | | | | |
|---|---|---|---|---|---|---|---|
| Destination | Source IP | Destination | Source | Protocol | DDOS | Attack | Violation |
| IP address | address | port | port | type | name | type | rule |

In Table 3, “DDOS name” refers to the name of the tool that sends DDOS attack commands, as detected after attack rules are matched successfully in the detection of single-packet DDOS feature packets. “Attack type” refers to the type of attack applied, and “violation rule” refers to successfully matched attack rules. Table 4 shows the data structure of the text body of a DDOS control event.

TABLE 4

| | | | | | | | |
|---|---|---|---|---|---|---|---|
| Destination | Source | Destination | Source | Protocol | DDOS | Control | Violation |
| IP address | IP | port | port | type | name | type | rule |
| | address | | | | | | |

In Table 4, “DDOS name” refers to the name of the tool that sends DDOS control commands, as detected after control rules are matched successfully in the detection of single-packet DDOS feature packets. “Control type” refers to the type of control applied, and “violation rule” refers to successfully matched control rules. Table 5 shows the data structure of the text body of a protocol traffic exception event.

TABLE 5

| | | | | | | |
|---|---|---|---|---|---|---|
| Des- | Source | Protocol | Traffic | Current | Action | Exception |
| tination | port | type | value | threshold | flag | type |
| port | | | | | | |

In Table 5, “traffic value” refers to the current traffic value; “current threshold” refers to a dynamic threshold, “action flag” indicates whether traffic is recovered, and “exception type” indicates the type of traffic exception.

Table 6 shows the data structure of the text body of a mass spam send event.

TABLE 6

| | | | | | | |
|---|---|---|---|---|---|---|
| Source IP | Quantity of | Quantity of | Traffic for | Last | User type | Exception |
| address | mails for | recipients | mail | detection | | type |
| | sending | | sending | time | | |

In Table 6, “source IP address” refers to the IP address of suspicious infected zombie host, and “quantity of mails for sending” refers to the quantity of mails for sending in a detection period. “Quantity of recipients” indicates the quantity of recipients who receive the mails, “traffic for mail sending” indicates the traffic of mails when the mails are sent, “user type” refers to whether the user is enterprise or individual, and “exception type” indicates the type of mail sending exception.

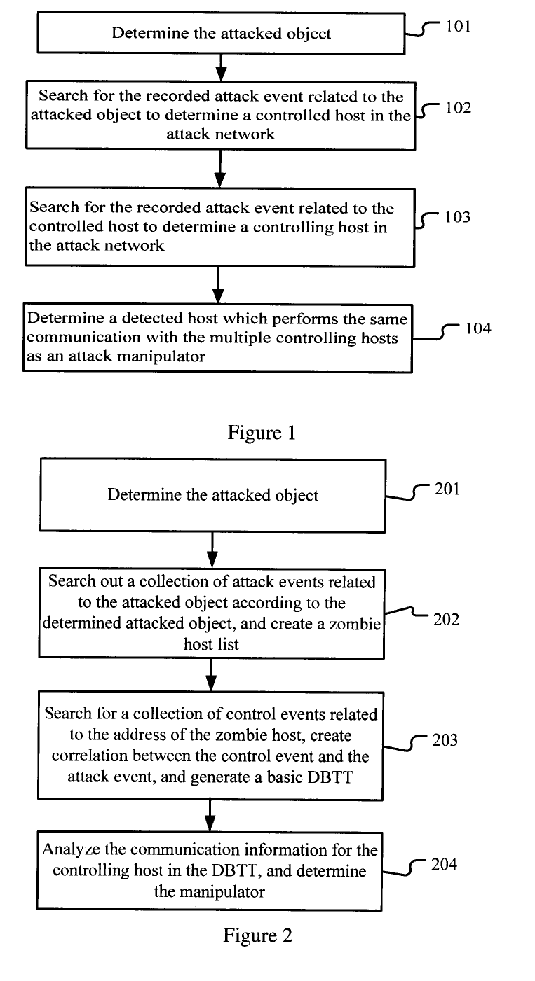

As shown in FIG. 2, the network attack processing method may include the following steps:

Step 201: Determining an attacked object.

In some embodiments, an attacked object modeling module may be used to perform this step. The module may read information of traffic exception events in an event collecting module, and determine a specific attacked object as an attacked object for correlative analysis according to priority of the traffic exception event. The determined attacked object may be generally represented by an IP address.

The event collecting module is a module for collecting relevant events. It reads the log information of relevant events from the logs which may be obtained by filtering the database. The relevant events may include, but are not limited to, protocol traffic exception event, frequency over-threshold event, DDOS attack event, connection exhaustion event, and DDOS control event. In another embodiment, other events may include a mass spam send event.

After the attacked object is determined, the attacked object modeling module creates relevant resources, and notifies a topology module of the determined attacked object.

Step 202: Identifying a collection of attack events related to the attacked object according to the determined attacked object, and creating a zombie host list, where a zombie host is a controlled host in the attack network.

The topology module analyses the attack real-time list recorded by an attack correlating module by using the IP address of the determined attacked object as a matching condition, searches out a collection of attack events targeted at this IP address, and creates a temporary zombie host list according to the attack packet in the attack event. In some cases, the zombie host is the sender of the attack packets in the attack event.

The attack real-time list of the attack correlating module may be created after the information of various events collected by the event collecting module is sorted according to the destination IP address. The events may include one or more following events: frequency over-threshold event; DDOS attack event; connection exhaustion event; and mass spam send event. The information of events may be reflected by the table entries described above.

Step 203: Searching for a collection of control events related to the address of the zombie host, determining the controlled host in the attack network, creating correlation between the control event and the attack event, and generating a basic DDOS Botnet Topology Table (DBTT).

According to the created zombie host list, the topology module analyzes all control real-time lists recorded in the control correlating module by using the IP address of the zombie host as a match condition, finds a collection of all control events targeted at this IP address, and creates correlation between each control event and each found attack event. That is, the module, correlates the controlling host determined according to the control packet with the zombie host in the zombie host list, thus forming a basic DBTT. Subsequently, the DBTT is maintained dynamically.

The control real-time list of the control correlating module is created after the information of DDOS control events collected by the event collecting module is sorted according to the source IP address.

Step 204: Analyzing the communication information for the controlling host in the DBTT, and determining the manipulator.

After the topology module generates a basic DBTT, the communication analysis module analyzes the communication information for multiple controlling hosts in the DBTT, for example, analyzes data information and connection information, searches out the host which performs the same communication with such controlling hosts, and determines this host is an attack manipulator and determines the IP address of this host is a manipulator IP address.

After determining the attack manipulator, the communication analysis module may return the manipulator IP address to the topology module, and the topology module may record the manipulator IP address into the DBTT, thus forming a final DBTT.

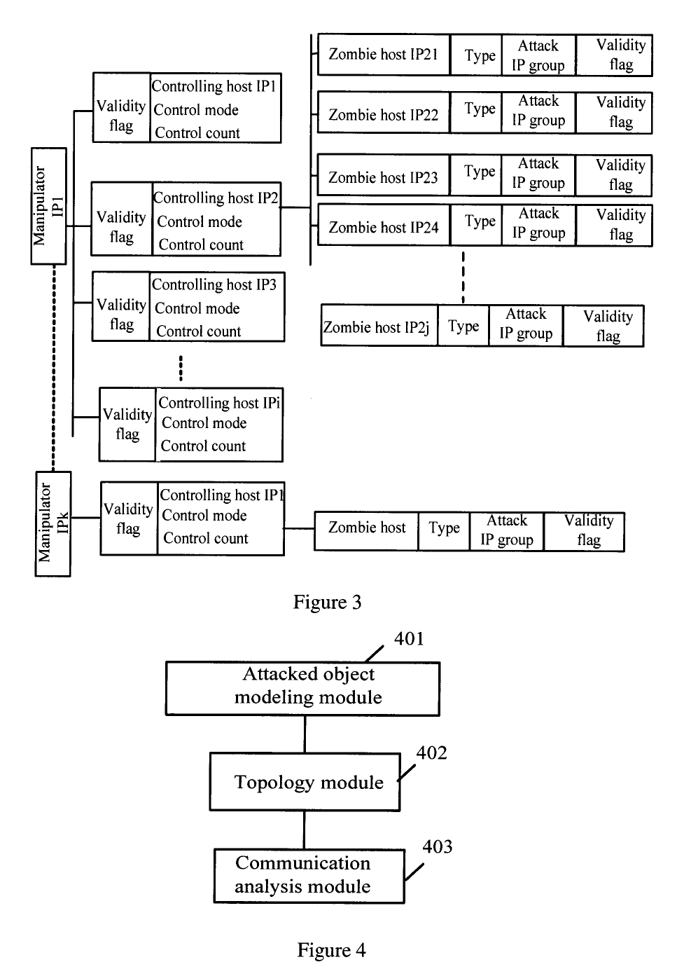

FIG. 3 shows a logic structure of main contents of a DBTT.

As shown in FIG. 3, the logic structure may include three layers. The first layer is a manipulator IP address, the second layer is information of the controlling host, including IP address, control mode, control count, and validity flag. The third layer includes information about the zombie host, including IP address, type, attack IP group, and validity flag.

The manipulator IP address is identified by obtaining communication information of the controlling host. The controlling host is identified by obtaining the control packets for the zombie host, and the zombie host is identified by obtaining the attack packet. In the third layer, “type” indicates the zombie type of the zombie host. “Attack IP group” is a collection of attacked destination IP addresses in the history record, and “validity flag” indicates whether the record is valid.

After the DBTT is completed through the foregoing steps, the outputting module may generate a blacklist periodically according to a policy or in real time for the DBTT, and then output the blacklist as guidance for subsequent attack processing such as traffic rinse.

In some embodiments, a correlative analysis technology may be used to analyze isolated events correlatively, thus obtaining a complete system of the whole DDOS attack network and detecting the true attack manipulator. Therefore, the whole DDOS attack network may be monitored and tracked conveniently, and necessary information is provided for subsequent traffic rinse, counterattack, and lawsuits. Besides, even if the attack organizer changes policies in the process of staging attacks, for example, initiates attacks intermittently, or changes attack method from time to time, or changes the IP address frequently, the true attack manipulator may still be found using the disclosed embodiments herein.

In some embodiments, an apparatus for processing network attack is provided. As shown in FIG. 4, the processing apparatus may include an attacked object modeling module 401, a topology module 402, and a communication analysis module 403.

The attacked object modeling module 401 is adapted to determine the attacked object.

The topology module 402 is adapted to, after the attacked object modeling module determines the attacked object, search for a recorded attack event related to the attacked object to determine a controlled host in an attack network, and search for a recorded control event related to the controlled host to determine a controlling host in the attack network.

The communication analysis module 403 is adapted to determine a detected host which performs the same communication with the multiple controlling hosts as an attack manipulator.

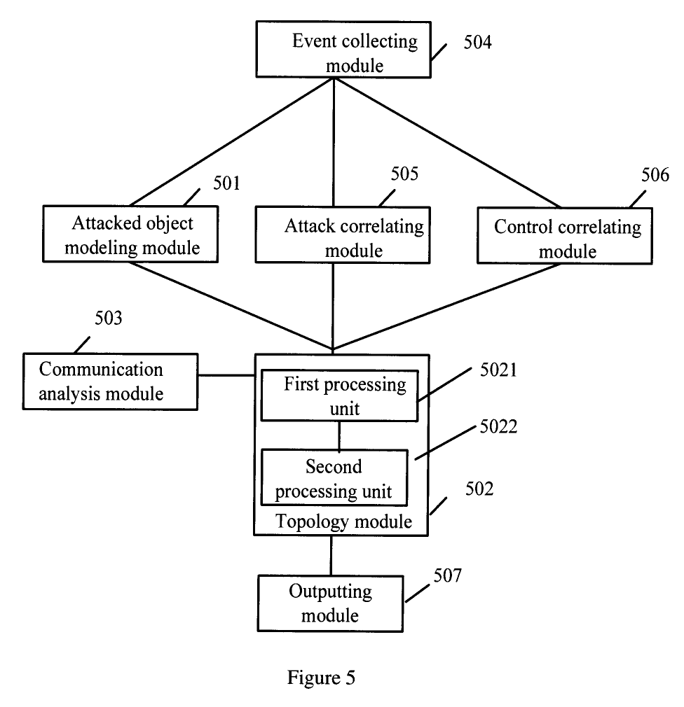

As shown in FIG. 5, the processing apparatus may further include an event collecting module 504.

The event collecting module 504 is adapted to collect event information from logs according preset conditions. The attacked object modeling module 501 determines the attacked object according to the priority of the traffic exception event collected by the event collecting module 504.

The processing apparatus may further include an attack correlating module 505.

The attack correlating module 405 is adapted to sort the information of multiple events in the event collecting module 504 by destination IP addresses and create an attack real-time list, wherein the multiple events may include, but is not limited to, one or more following events: frequency over-threshold event; DDOS attack event; connection exhaustion event; and mass spam send event. The topology module 502 searches the attack real-time list for the recorded attack events related to the attacked object.

The processing apparatus may further include a control correlating module 506.

The control correlating module 506 is adapted to sort the information of various control events in the event collecting module 504 by the source IP address and then create a control real-time list. The topology module 502 searches the control real-time list for the recorded control event related to the controlled host according to the controlled host.

Furthermore, the topology module 502 in the processing apparatus may further include, a first processing unit 5021 and a second processing unit 5022.

The first processing unit 5021 is adapted to search the attack real-time list created by the attack correlating module 505 for the attack event targeted at the attacked object by using the IP address of the attacked object as a match condition, and determine the controlled host in the attack network.

The second processing unit 5022 is adapted to search the control real-time list created by the control correlating module 506 for the control event targeted at the controlled host by using the IP address of the controlled object as a match condition, and determine the controlling host in the attack network.

In some embodiments, the processing apparatus may further include an output 507.

From the controlled host, controlling host and attack manipulator obtained above, the topology module 502 may further make up a topology data table DBTT. The outputting module 507 generates a blacklist periodically according to a policy or in real time for the DBTT, and then outputs the blacklist as guidance for subsequent attack processing such as traffic rinse.

In some embodiments, the processing apparatus may be independent monitor equipment, or may be placed in a network analyzing monitor center in the Internet.

In other embodiments, the processing apparatus may find the true attack manipulator by analyzing isolated events correlatively applying a analysis technology. The other contents may refer to embodiment previously described.

It is understandable to those skilled in the art that all or part of the foregoing embodiments may be implemented by hardware instructed by computer-readable code or instructions. The computer-readable instructions may be stored in a computer readable storage medium configured to execute the steps of foregoing method.

Through the above descriptions of the embodiments of the present invention, those skilled in the art can clearly understand that the embodiments can be implemented using a combination of software plus a universal hardware platform or by hardware only. Based on such an understanding, the embodiments of the present invention may be embodied by computer-readable code tangibly embodied on a computer-readable storage medium which includes code for performing the methods according to the embodiments of the present invention. The computer-readable storage medium mentioned above may be a Read-Only Memory (ROM), Random Access Memory (RAM), disk or CD.

For those skilled in the art, the specific implementation mode and application scope of the present invention may vary based on the ideas of the embodiments of the present invention. In a word, the contents of this document are not intended to limit the present invention.

What is claimed is:

1. A method for processing network attack, comprising:
after determining an attacked object, searching for a recorded attack event related to the attacked object to determine a controlled host in an attack network;
searching for a recorded control event related to the controlled host to determine a controlling host in the attack network; and
determining a detected host which performs the same communication with multiple controlling hosts as an attack manipulator.

2. The method for processing network attack of claim 1, wherein determining an attacked object comprises:
determining the attached object according to priority information of traffic exception events.

3. The method for processing network attack of claim 1, wherein searching for a recorded attack event related to the attacked object comprises:
searching a created attack real-time list for the attack event targeted at the attacked object by using an IP address of the determined attacked object as a matching condition.

4. The method for processing network attack of claim 3, wherein the attack real-time list is obtained after sorting information of multiple events by destination IP addresses, wherein the multiple events include one or more following events: frequency over-threshold event, DDOS attack event, connection exhaustion event, and mass spam send event.

5. The method for processing network attack of claim 1, wherein the searching for a recorded control event related to the controlled host comprises: searching a created control real-time list for the control event targeted at the controlled host by using an IP address of the controlled object as a match condition.

6. The method for processing network attack of claim 5, wherein the control real-time list is obtained after sorting collected information of various control events by source IP addresses.

7. An apparatus for processing network attack, comprising:
an attacked object modeling module, adapted to determine an attacked object;
a topology module, adapted to, after the attacked object modeling module determines the attacked object, search for a recorded attack event related to the attacked object to determine a controlled host in an attack network, and search for a recorded control event related to the controlled host to determine a controlling host in the attack network; and
a communication analysis module, adapted to determine a detected host which performs the same communication with multiple controlling hosts as an attack manipulator.

8. The apparatus for processing network attack of claim 7, further comprising:
an event collecting module, adapted to collect event information from logs according preset conditions;
wherein the attacked object modeling module is further adapted to determine the attacked object according to a priority of the traffic exception event collected by the event collecting module.

9. The apparatus for processing network attack of claim 8, further comprising:
an attack correlating module, adapted to sort the information on of multiple events in the event collecting module by destination IP addresses and create an attack real-time list;
wherein the topology module is further adapted to search the attack real-time list for the recorded attack events related to the attacked object.

10. The apparatus for processing network attack of claim 8, further comprising:
a control correlating module, adapted to sort the information of various control events in the event collecting module by the source IP address and create a control real-time list;
wherein the topology module is further adapted to search the control real-time list for the recorded control event related to the controlled host.

11. The apparatus for processing network attack of claim 10, wherein the topology module further comprises:
a first processing unit, adapted to search the attack real-time list created by the attack correlating module for the attack event targeted at the attacked object by using an IP address of the attacked object as a match condition, and determine the controlled host in the attack network;
a second processing unit, adapted to search the control real-time list created by the control correlating module for the control event targeted at the controlled host by using the IP address of the controlled object as a match condition, and determine the controlling host in the attack network.

12. A network analyzing monitor center, comprising:
an attacked object modeling module adapted to determine the attacked object;
a topology module adapted to, after the attacked object modeling module determines the attacked object, search for a recorded attack event related to the attacked object to determine a controlled host in an attack network, and search for a recorded control event related to the controlled host to determine a controlling host in the attack network; and
a communication analysis module adapted to determine a detected host which performs the same communication with the multiple controlling hosts as an attack manipulator.

13. The network analyzing monitor center of claim 12, further comprising:
an event collecting module adapted to collect event information from logs according preset conditions;
wherein the attacked object modeling module is further adapted to determine the attacked object according to a priority of the traffic exception event collected by the event collecting module.

14. The network analyzing monitor center of claim 13, further comprising:
an attack correlating module, adapted to sort the information on of multiple events in the event collecting module by destination IP addresses and create an attack real-time list;
wherein the topology module is further adapted to search the attack real-time list for the recorded attack events related to the attacked object.

15. The network analyzing monitor center of claim 13, further comprising:
a control correlating module adapted to sort the information of various control events in the event collecting module by the source IP address and create a control real-time list;
wherein the topology module is further adapted to search the control real-time list for the recorded control event related to the controlled host.

16. The network analyzing monitor center of claim 15, wherein the topology module further comprises:
a first processing unit adapted to, search the attack real-time list created by the attack correlating module for the attack event targeted at the attacked object by using the IP address of the attacked object as a match condition, and determine the controlled host in the attack network; and
a second processing unit, adapted to, search the control real-time list created by the control correlating module for the control event targeted at the controlled host by using the IP address of the controlled object as a match condition, and determine the controlling host in the attack network.
